(19) United States
(12) Patent Application Publication
(10) Pub. No.: US 2018/0050753 A1
(43) Pub. Date: Feb. 22, 2018

(54) A DEVICE SUITABLE FOR PROTECTING AND/OR ALLOWING CLEANING OF A BIKE AND/OR VEHICLE COMPONENT AND METHOD OF USE THEREOF

(71) Applicants: Esther Lee, Huddersfield Yorkshire (GB); Jonathan Lee, Huddersfield Yorkshire (GB); Gareth Bransby, Greater Manchester (GB)

(72) Inventors: Jonathan Lee, Huddersfield Yorkshire (GB); Gareth Bransby, Greater Manchester (GB); Ertu Unver, Huddersfield Yorkshire (GB); Robert Silkstone, Huddersfield Yorkshire (GB)

(21) Appl. No.: 15/557,540

(22) PCT Filed: Jan. 27, 2016
(86) PCT No.: PCT/GB2016/050167

§ 371 Date: Sep. 12, 2017

(30) Foreign Application Priority Data
Mar. 12, 2015 (GB) 1504165.0

(51) Int. Cl. B62J 13/00; F16D 65/00; F16H 57/04; F16N 31/00

(52) U.S. Cl. CPC B62J 13/00; F16D 65/0031; B62J 2099/0066; F16N 31/006; F16H 57/0402

(57) ABSTRACT

A device is provided for protecting, allowing cleaning, servicing and/or lubrication of one or more components of a bike or vehicle in use. The device is formed from at least one blank of material including a first portion arranged to act as a shield element so as to at least partially shield at least one component of the vehicle or bike in use, and at least a second portion. The second portion includes at least one wall joined to the first portion by at least one fold line. The at least one wall and fold line are arranged such that when the second portion is assembled and/or erected in use it defines a tray or container portion joined to the first portion.

This invention relates to a device suitable for protecting, allowing cleaning, servicing and/or lubrication of a bike and/or vehicle component, such as for example a brake and/or disc component of a bike, and a method of use thereof.

Although the following description refers almost exclusively to a brake and/or disc protection device for use on the rear wheel of a bicycle, it will be appreciated by persons skilled in the art that the device of the present invention could be used on any type of wheeled vehicle, such as for use on a motorbike, tricycle and/or the like, for shielding, protecting, allowing cleaning, servicing and/or lubrication of any or any combination of components of a bike or vehicle. The device of the present invention can be used to shield a part or whole of the locality in which the bike or vehicle is located in use. The device of the present invention can also be used to isolate or separate one or more components, such as for example the brake and/or disc, from one or more other components, such as for example the gear cassette, rear derailleur, chain and/or the like.

It is known to provide a brake and/or disc protector for location over a brake and/or disc of a bicycle or a motor bike during cleaning processes, lubricating processes and/or the like.

The protector typically prevents any cleaning fluid or lubricant from coming into contact with the brake and/or disc of the bike during the cleaning and/or lubricating process, which might significantly reduce the braking performance of the brake and/or disc in use.

GB2477726 discloses a brake shield comprising two circular flexible and waterproof members which are joined together by stitching. Each member has a radial slit to allow the same to be located around the brake disc. The two members overlap to cover the brake disc. A problem with this product is that any cleaning fluid or lubricator impacting with the circular member eventually drips down to the base edge of the member and onto the floor on which the bike is being cleaned. This creates a mess in the area of where the bike is being cleaned, which is undesirable and which might result in a slipping hazard to animals or people. A user therefore typically has to clean/lubricate the bike and then clean the surrounding locality of the cleaning/lubrication fluid afterwards. This is time consuming for the user and it may be difficult to remove all trace of the spilt/dripped cleaning/lubricating fluid from floor surfaces on which the bike was cleaned.

In an attempt to overcome this problem it is known to provide a motor bike brake shield with an integral and rigid sump. The sump collects run off of any cleaning/lubricating fluid used on the motor bike during maintenance. A pouring spout can be provided on the sump to allow the collected fluid to be decanted into a container for safe disposal. This shield is typically relatively expensive to produce, large and difficult to transport. This is particularly a problem where the bike may need to be maintained or serviced away from the user's home or normal base, such as when the user is travelling, on holiday, at races and/or the like.

GB2417935 discloses a removable cleaning shield comprising a disc formed from moulded plastic. The disc has a trough which collects excess cleaning and lubrication fluid. A central hinge allows the shield to be folded in half for storage and a hole is provided to allow it to be hung up. However, due to the presence of the fixed trough, the shield cannot be folded flat and therefore is still relatively large and cumbersome to transport and store.

It is therefore an aim of the present invention to provide a device suitable for protecting, allowing cleaning, servicing and/or lubrication of one or more components of a vehicle and/or bike that overcomes the abovementioned problems.

It is a further aim of the present invention to provide a method of using a device for protecting, allowing cleaning, servicing and/or lubrication of a bike and/or vehicle component that overcomes the abovementioned problems.

It is a yet further aim of the present invention to provide a brake and/or disc isolation, protection and/or separation device for isolating, protecting and/or separating the brake and/or disc from one or more other components on a bike or vehicle.

It is a yet further aim of the present invention to provide a method of using a brake and/or disc isolation, protection and/or separation device.

According to a first aspect of the present invention there is provided a device for protecting, allowing cleaning, servicing and/or lubrication of one or more components of a bike and/or vehicle in use, said device formed from at least one blank of material including a first portion arranged to act as a shield element so as to at least partially shield at least one component of the vehicle or bike in use, and at least a second portion, said second portion including at least one wall joined to the first portion by at least one fold line, the at least one wall and fold line arranged such that when the second portion is assembled and/or erected in use it defines a tray or container portion joined to the first portion.

In one embodiment the device is a brake and/or disc protection device. The first portion is arranged to act as a shield element so as to at least partially shield the brake and/or disc of a vehicle or bike in use.

Thus, the present invention provides a device having a foldable tray or container portion, thereby allowing run off of fluid, dirt and/or debris to be collected during cleaning, servicing and/or lubrication processes when the device is an assembled, erect and/or in-use condition, and which allows the device to be moved to or folded to a flat or substantially flat condition when in a disassembled, collapsed, partially collapsed and/or out-of-use condition. This increases the case with which the device can be transported and/or stored. It is therefore much easier for a bike rider, for example, to be able to transport the device to races, on holiday, to training venues and/or the like. The present invention can also be used to protect any or any combination of components of the bike or vehicle, such as for example, the bike tyres, the wheel rims and ultimately the callipers and braking power of wheel rim brakes. The protection of such features maintains the efficiency of the brakes and the stopping distance of the bike or vehicle.

It is to be noted that the device can be fully assembled (with the tray or container portion formed) but still foldable to a flat, planar or substantially flat or planar condition in use.

Preferably the at least one blank is movable from a disassembled, flat, planar, substantially flat or substantially planar condition to an assembled and/or erect condition in use. The at least one blank is movable between the two conditions by moving the first and/or second portions relative to each other and/or about the one or more fold lines.

The tray or container portion is not formed or assembled when the at least one blank is in the disassembled condition.

In use of the device in one embodiment, the device is fitted to a side of a bike wheel on which the gear cassette is fitted, and between the wheel and the gear cassette, rear derailleur and/or chain. The device therefore acts to isolate or separate the gear cassette, rear derailleur and/or chain from the brake and/or disc provided on the opposite side of the bike wheel. Thus, the device can be used to protect the brake and/or disc during cleaning, servicing and/or lubricating processes undertaken on the gear cassette, rear derailleur and/or chain. The device can also be used to isolate the brake and/or disc from the other bike components to allow the brake and/or disc to be cleaned and/or repaired. Thus, in one arrangement, the device of the present invention can act as a cleaning aid device, an isolation or separation device and/or a protection device and is not specifically limited to protecting just a brake and/or disc component(s) of the bike or vehicle but any component(s) of the bike or vehicle.

In use of the device in one embodiment, the device is fitted to a side of a bike wheel on which a brake disc is provided, and between the wheel and the brake disc. The wheel can be the front and/or rear wheel of the bike. The device can be used to collect any dirt and/or fluid associated with cleaning the brake discs. In this embodiment the device is also acting as a cleaning aid device.

Preferably the one or more components of the bike and/or vehicle which are to be protected, separated, cleaned, serviced and/or the like are any or any combination of a wheel, wheel rim, brake and/or disc, gear cassette, rear derailleur, chain, wheel axle, wheel spokes and/or the like.

Preferably the term “shield” also means to cover, hide, isolate, protect and/or the like.

Preferably the second portion comprises or consists of two or more walls, and further preferably a plurality of walls, separated by fold lines, the walls and fold lines are arranged such that when the second portion is assembled or erected in use, it provides a tray or container portion joined to, and preferably integral with, the first portion.

Preferably the second portion is moved from a disassembled, flat, planar, substantially flat or planar condition to an erect and/or assembled condition by moving one or more walls of the second portion about one or more fold lines relative to one or more other walls of the second portions and/or first portion to form the tray or container portion.

In one embodiment the second portion can form a tray or container portion on one side of the first portion only. Preferably the side on which the tray or container portion is formed protrudes outwardly of the bike or vehicle in use.

In an alternative embodiment the second portion can form a tray or container portion on either side of the first portion (i.e. the front or rear surface of the first portion), and/or both sides of the first portion (i.e. the front and rear surfaces of the first portion).

Preferably the tray or container portion, once formed, has an opening. Preferably a longitudinal axis of the opening is parallel or substantially parallel to a longitudinal axis of the bike or vehicle.

Preferably the opening of the tray or container portion faces upwardly towards a top edge of the device. Preferably the tray or container portion is formed at or adjacent a base or base edge of the device and the opening of the tray or container portion faces upwardly towards an opposite edge, top or top edge of the device.

Preferably the opening of the tray or container portion is arranged to face upwardly towards a gear cassette, chain, brake, disc and/or rear derailleur of a bike when assembled on a bike in use.

In one embodiment the second portion includes at least a front wall joined to the first portion by a fold line. Preferably one or more side walls are joined to the front wall of the second portion and to the first portion by fold lines. Further preferably two side walls are provided, each side wall provided either side of the front wall of the second portion. The front and side walls of the blank are movable in use and folded along the fold lines to form the erect tray or container portion.

Preferably the at least one wall of the second portion forms a front wall of the tray or container portion in use and is joined to the first portion along a first fold line, one or more side walls are provided and are joined to the front wall of the second portion and/or to the first portion by at least second or further fold lines.

Preferably the side walls are folded inwardly of the second portion and/or tray or container portion to form the tray and/or container portion.

In one embodiment the first portion comprises a single wall.

In one embodiment the first portion comprises two or more walls separated by at least one fold line, the walls and the fold line(s) arranged such that the first portion and/or one or more walls of the first portion can be moved relative to one or more other walls of the first and/or second portions between an assembled, erect or in-use condition, and a disassembled, folded, collapsed or out-of-use position.

In one embodiment the device is formed from or consists of a single blank of material.

In one embodiment the device is formed from or consists of first and at least second blanks of material. The first and second portions can be provided on the first blank or the second blank of material.

Preferably engagement means or mechanism are provided on or associated with the at least one blank of material, the first portion and/or second portion of the device to allow the device to engage with a part of a bike or vehicle in use, such as for example to be located around, over or associated with a wheel, wheel axle/hub, brake and/or disc or other vehicle or bike component in such a manner so as to at least partially shield the brake and/or disc and/or other vehicle component in use.

In one embodiment the engagement means or mechanism allows the device, and preferably the first portion of the device or blank, to locate at least partially around the wheel axle/hub of a bike. In one example this allows the device to be fitted between one end of the wheel axle of the bike and the gear cassette, rear derailleur and chain of the bike associated with said end of the wheel axle. In another example, this allows the device to be fitted between the wheel axle and a brake disc on the front and/or rear wheel of the bike or vehicle.

In one embodiment the engagement means or mechanism includes or consists of at least one further blank of material or a second blank of material.

Preferably the further or second blank is movably mounted on or relative to the first blank. Preferably this allows movement of the second or further blank between an engaged position, wherein the second or further blank secures or helps to secure engagement of the first blank to the bike or vehicle in use, and a disengaged position, wherein the second or further blank is moved to a position such that the first blank can be removed from and/or located onto a part of a bike or vehicle in use.

Preferably the further or second blank of material is hingedly, pivotably, rotatably and/or slidably movable relative to the first blank of material. Alternatively, or in addition, the blanks of material are capable of relative hinging, pivoting, rotating or sliding movement.

Preferably the first and/or the second blanks of material can have the first and second portions provided thereon. In a preferred embodiment the first blank of material has the first and second portions defined thereon and the second blank of material is capable of movement relative to the first blank when assembled.

Preferably the second blank of material includes a single wall or panel.

Preferably the second blank is flat, planar, substantially flat or planar in the disassembled and/or assembled conditions.

In one embodiment the engagement means or mechanism are provided on the first and/or second blanks.

In one embodiment the engagement means or mechanism include or are in the form of any or any combination of one or more slits, slots, channels, spaces, apertures and/or recesses formed or defined in the first blank, the second blank, the first portion, the second portion and/or the like.

In one embodiment the first blank has engagement means in the form of a slit, slot, channel, aperture and/or recess which allows the first blank to be fitted to the bike or vehicle in use. Preferably the second blank is moved relative to the first blank to cover at least part of the slit, slot, channel, aperture and/or recess of the first blank to form the engaged position in use. Preferably the second blank is moved clear or substantially clear of the slit, slot, channel, aperture and/or recess of the first blank to form the disengaged position.

Preferably one or more pin members or pivot means are used to allow the second or further blank of material to pivot relative to the first blank of material in use or vice versa.

Preferably the one or more pin members or pivot means are attached or detachably attached to the first and/or second blanks of material.

Preferably the engagement means or mechanism, slit, slot, channel, aperture and/or recess is arranged from an interior position, central position or relatively central position on the first and/or second blank to a peripheral edge of said blank(s).

In a preferred embodiment a radial slit is defined in the first portion of the first blank and/or the slit is located between a middle, central or interior position of the first portion of the first blank to a peripheral edge of the first portion.

In one embodiment attachment means or further attachment means are provided on the first blank, second blank and/or at least one blank to allow at least part of the device to be attached to at least part of the bike or vehicle in use.

Preferably the attachment means are arranged a spaced distance apart from, and are in addition to, the engagement means or mechanism provided on the first blank and/or the second blank.

The attachment means could include any or any combination of one or more clips, protrusions, tabs, flanges, ties, straps, buckles, inter-engaging members, VELCRO® (hook and loop fastening) and/or the like.

Preferably the attachment means are provided at or adjacent a peripheral edge or edges of the device, first blank and/or second blank.

Preferably the attachment means are provided on or associated with the first blank of material.

Preferably the at least one blank, the first blank, the second blank and/or first portion include at least one aperture for location around the front and/or rear axle of a bike or vehicle wheel in use. The aperture may be of sufficient shape, design and/or dimensions, in some embodiments, to retain the device in position without the use of any further attachment means.

Preferably the at least one aperture is located substantially centrally, in the middle of or in the interior (a spaced distance from the edges) of the at least one blank, the first portion, the first and/or second blanks.

In one embodiment the at least one aperture is co-axial with an axis or central axis of the first portion, the first blank and/or the second blank.

Preferably the at least one aperture is in communication with and/or is continuous with the engagement means, engagement mechanism, slit, slot, recess, aperture and/or channel passing between the middle or interior of the first blank, second blank and/or first portion to the peripheral edge thereof.

The first portion, first blank and/or second blank can be any suitable shape so as to act as a shield or isolation member for at least part of the brake and/or disc or vehicle or bike component(s) and preferably the entire or substantially entire brake and/or disc or vehicle or bike component(s).

Preferably the first portion, first blank and/or second blank is circular, substantially circular, oval or substantially oval in shape.

Preferably the first and at least second blanks are provided in partially overlapping, wholly overlapping or substantially wholly overlapping arrangement when in the assembled condition.

Preferably the second portion is joined to or integral with the first portion so that the tray or container portion, when assembled, is provided adjacent to, adjoining or at a peripheral edge of the first portion.

Preferably the tray or container portion protrudes outwardly from a front surface of the first portion when assembled, and thus protrude outwardly from a side of the wheel in use.

Preferably the second portion is joined to or integral with the first portion so that the tray or container portion, when assembled, is provided adjacent to, adjoining or at a base edge of the first portion in use. As such, any fluid, debris or dirt falling and/or flowing from the bike or vehicle will fall into the tray or container portion as a result of gravity.

In one embodiment a securing means or mechanism can be provided on or associated with the at least one blank, the first blank, at least second blank, second and/or first portions so as to allow the first and second blanks to remain in an engaged and/or disengaged position, and/or to allow the first and/or second portions to remain in the assembled and/or erect condition, or in a folded and/or collapsed condition in use.

Preferably the securing means can include any or any combination of one or more apertures, protrusions, tabs, flanges, clips, ties, straps, buckles, pins, inter-engaging members, VELCRO® (hook and loop fastening) and/or the like.

Preferably the device is formed from or consists of a flexible or substantially flexible material. Alternatively, the device can be formed from or consist of a rigid or substantially rigid material providing there are one or more fold lines or hinge means to allow the second portion to be moved relative to the first portion between a relatively flat condition to an erect condition in use to form a tray or container portion.

The device could be formed from any or any combination of plastic, wood, paper, cardboard, metal and/or the like.

Preferably the material from which the at least one blank is formed consists of or includes a sheet like material.

Preferably the at least one blank is formed from a flat, planar, substantially flat or substantially planar material.

Preferably the material is polypropylene.

Preferably the user moves the blank between the assembled and disassembled conditions or the erect and collapsed positions without the use of any special tools or skill requirement.

Preferably the device is formed from a water proof or water resistant material or at least part of it is provided with a water proof or water resistant coating, layer and/or the like thereon. This prevents the device from getting damaged and/or marked if it comes into contact with cleaning and/or lubrication fluid in use.

The device can be any suitable size, shape and/or dimensions for acting as a shield or separation member for the brake and/or disc or one or more other components on a bike or vehicle on which it is used.

In one embodiment one or more frangible means, weakened means and/or partial cut lines can be provided on the first and/or second blanks to allow the blanks to be cut to a required size in use. In one embodiment the frangible means, weakened means and/or partial cut lines are provided in lines that are a spaced distance apart and parallel or substantially parallel to each other, thereby allowing the user to select which line to cut along that will reduce the size of the blank(s) to fit a particular bike or vehicle.

Preferably the one or more frangible means, weakened means and/or partial cut lines are provided on the blank adjacent to or in association with the engagement means or mechanism, the attachment means or mechanism, the aperture for location around a wheel axle in use, an outer edge of the blank and/or the like.

According to a second aspect of the present invention there is provided a device for shielding one or more components of a vehicle or bike in use and/or during one or more cleaning, spraying, lubricating, servicing processes and/or the like.

According to a further aspect of the present invention there is provided a brake and/or disc protection device ad a method of use thereof.

According to further independent aspects of the present invention there is provided a separation or isolation device for separating or isolating a bike or vehicle component, brake and/or disc on a bike or vehicle from one or more other components of the bike or vehicle. The separation or isolation device allows separation or isolation of parts of the bike or vehicle for the purposes of cleaning, lubrication and/or repair.

Preferably the vehicle is a bicycle, motor bike, tricycle and/or the like.

According to a third aspect of the present invention there is provided at least one blank for forming a device for protecting, allowing cleaning, servicing and/or lubrication of one or more components of a bike and/or vehicle.

Preferably the blank is movable from a flat or substantially flat condition to an erect or at least partially erect condition.

According to a further aspect of the present invention there is provided first and at least second blanks for forming a device for protecting, allowing cleaning, servicing and/or lubrication of one or more components of a bike and/or vehicle.

It is to be noted that once the device is assembled from the blank, the device can be disassembled to move it to a flat or substantially flat condition or the device could remain assembled and be movable to a flat or substantially flat condition.

According to a fourth aspect of the present invention there is provided a method of forming a device for protecting, allowing cleaning, servicing and/or lubrication of one or more components of a bike and/or vehicle, said device comprising at least one blank of material including a first portion arranged to act as a shield element so as to at least partially shield at least one component of vehicle or bike in use, and at least a second portion, said second portion including at least one wall joined to the first portion by at least one fold line, said method including the steps of folding the at least one wall of the second portion along the at least one fold line to form a tray or container portion joined to the first portion.

Preferably the device is a brake and/or disc protection device.

According to a fifth aspect of the present invention there is provided a method of using a device for protecting, allowing cleaning, servicing and/or lubrication of one or more components of a bike and/or vehicle. The method includes the step of locating the assembled or erected device onto part of a bike or vehicle that is to be cleaned and/or protected.

According to a further aspect of the present invention there is provided a brake and/or disc protection device for protecting the brake and/or disc of a bike or vehicle during cleaning and/or lubricating processes, said device formed from at least one blank of material including a first portion arranged to act as a shield element so as to at least partially shield the brake and/or disc in use, and at least a second portion, said second portion including at least one wall joined to the first portion by at least one fold line, the at least one wall and fold line arranged such that when the second portion is assembled and/or erected in use it defines a tray or container portion joined to the first portion.

Embodiments of the present invention will now be described with reference to the accompanying figures, wherein:

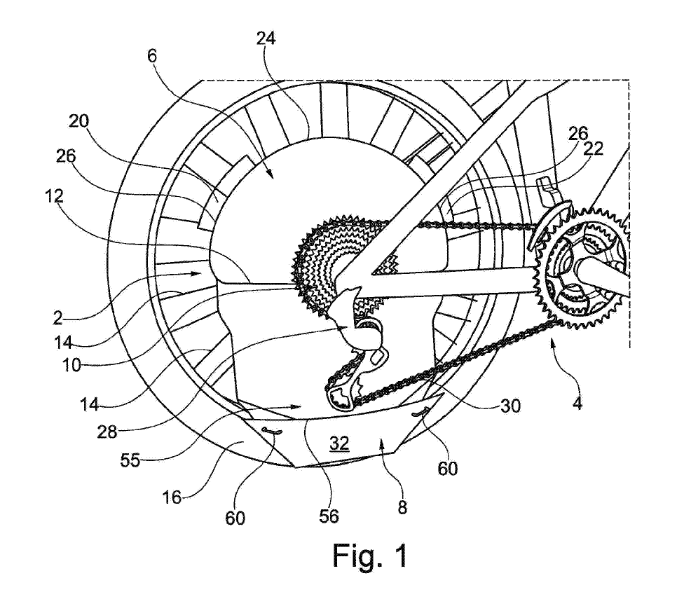

FIG. 1 illustrates a brake and disc protection device according to one embodiment of the present invention in use in an assembled condition on a bicycle;

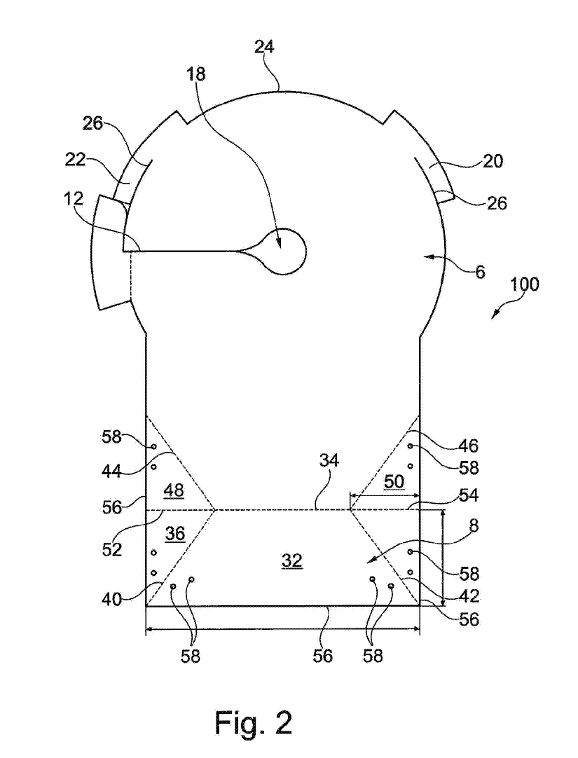

FIG. 2 illustrates the blank used to form the device in FIG. 1;

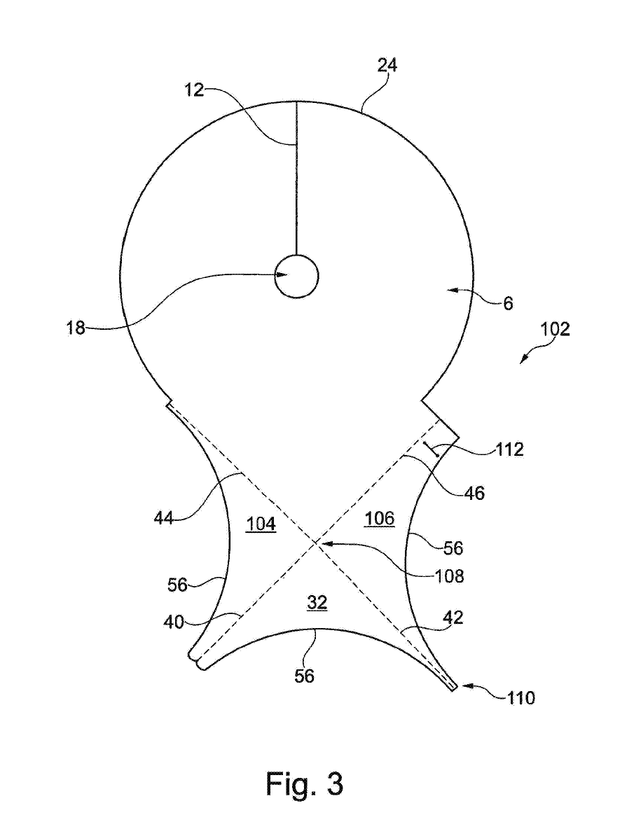

FIG. 3 illustrates the blank according to a further embodiment of the present invention;

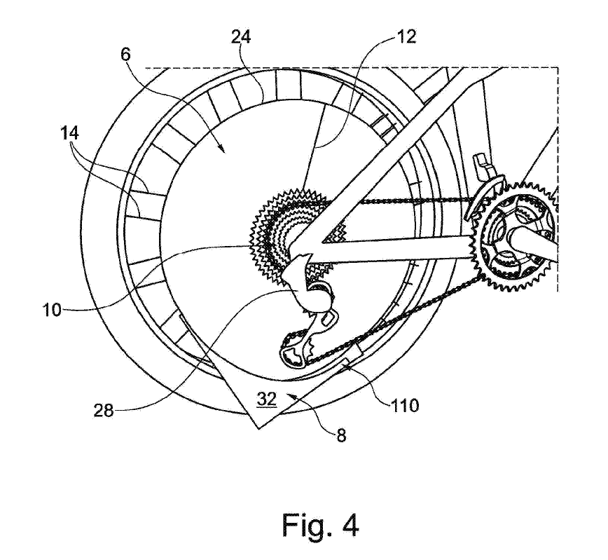

FIG. 4 illustrates the device formed from the blank in FIG. 3;

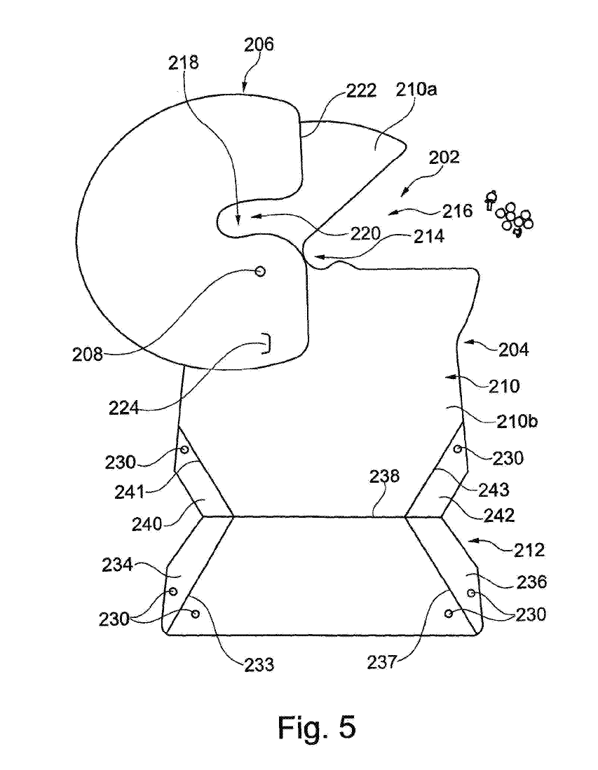

FIG. 5 illustrates a brake and disc protection device comprising first and second blanks prior to erection of the device and in a disengaged position according to a further embodiment of the present invention;

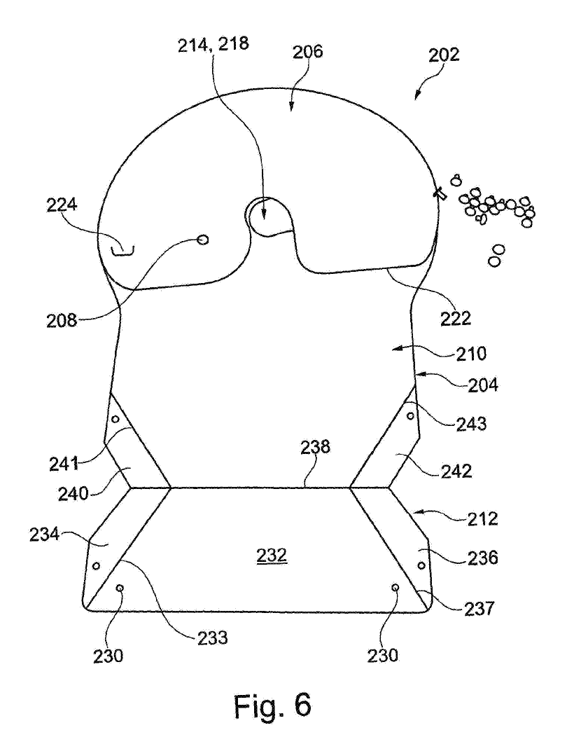

FIG. 6 shows the brake and disc protection device in FIG. 5 in an engaged position;

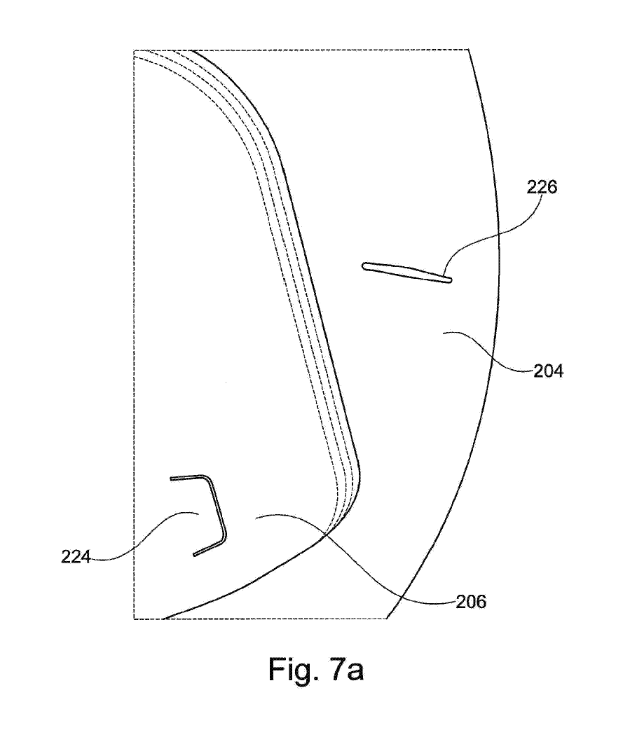

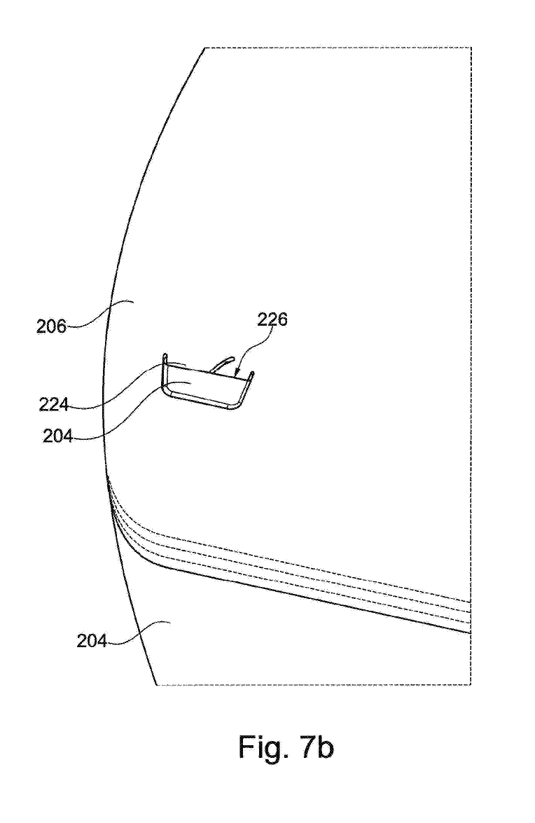

FIGS. 7a and 7b show an enlarged view of securing means used on the first and second blanks in a disengaged position and an engaged position respectively;

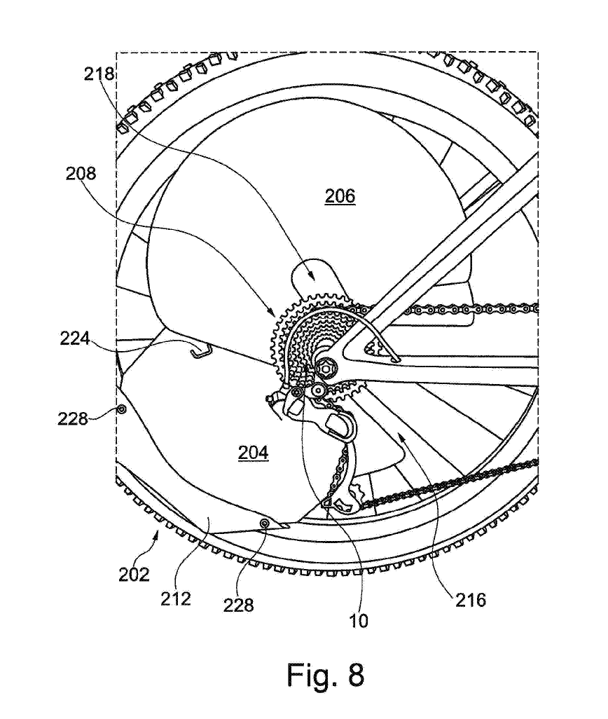

FIG. 8 shows the brake and disc protection device of FIGS. 5-7b fitted to a bike in use in a disengaged position;

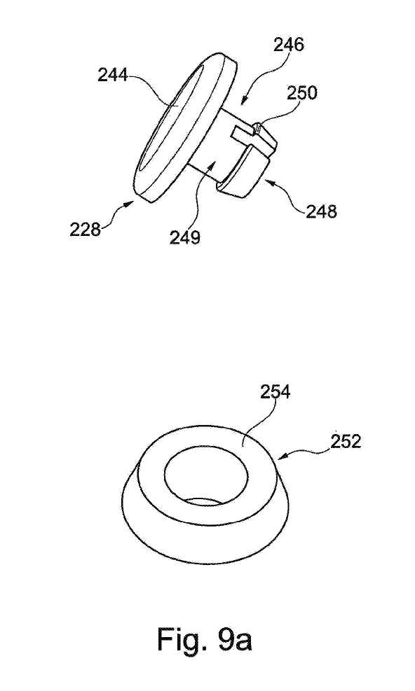

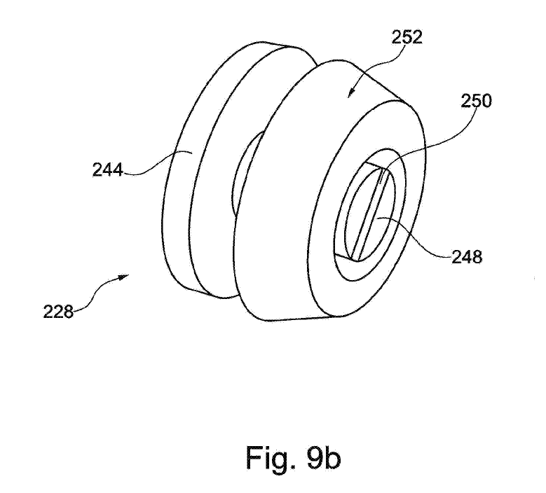

FIGS. 9a and 9b show an example of a pin that can be used as the pivot pin, for securing a first blank to a second blank and/or for securing the first portion to the second portion; and

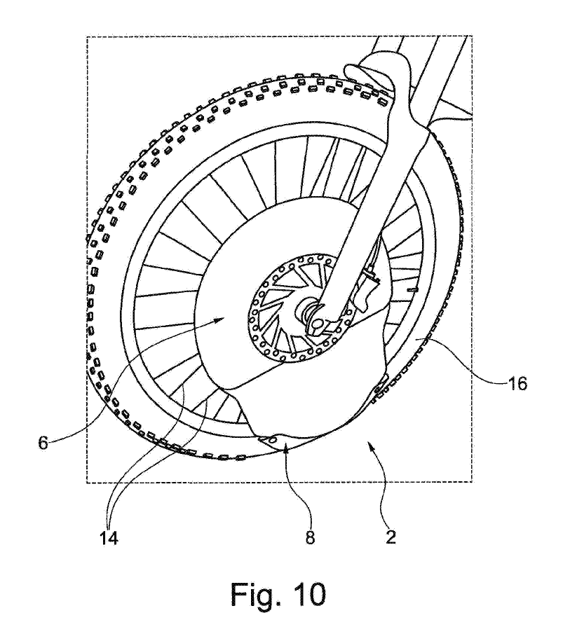

FIG. 10 shows an example of a brake and disc protection device fitted around the axle of a front wheel of a bike between the brake disc and the wheel.

Referring to FIG. 1, there is illustrated a brake and disc protection device 2 for use on a bicycle 4. The device 2 includes a first portion 6 acting as a shield for the brake and disc of the bike and a second portion 8 acting as a tray to collect fluid run off, dirt and/or debris that may result from a cleaning and/or lubricating process undertaken on the chain and gear mechanism 10 of the bike.

The first portion 6 has a circular external shape and has engagement means in the form of a radial and linear slit 12 defined therein from the centre to a peripheral edge of the first portion to allow the first portion to be slotted onto the wheel axis between the gear mechanism/cassette 10 and the spokes 14 of the bike wheel 16. The brake and disc are located on the opposite side of the wheel spokes 14/wheel 16 to the gear mechanism 10 and are therefore shielded by first portion 6 when the device 2 is fitted to the bike. It will also be appreciated that as well as shielding, the device 2 can act as a separation or isolation member, so that the brake and disc are separated or isolated from the gear mechanism/cassette 10, thereby allowing the brake and disc to be cleaned and/or repaired without effecting the gear mechanism/cassette 10.

An aperture 18 is defined in first portion 6 for the location of an end of the rear bike wheel axle therethrough when the device is fitted to the bike. The aperture 18 is continuous with and in communication with the slit 12. The end of the wheel axle is pushed through the slit until the end of the wheel axle sits in aperture 18 in use.

Attachment means for attaching the device to the bike are provided in the form of circumferential protrusions 20, 22. The protrusions 20, 22 are provided a spaced distance apart adjoining a top edge 24 of the device 2. A slit 26 is defined between each protrusion 20, 22 and the first portion 6 to allow the protrusion to be attached to the wheel spokes 14 in use. The circumferential protrusions are planar with the first portion 6 and protrude radially outwardly beyond the peripheral edge of the first portion.

The first portion 6 is typically of such dimensions so as to shield the part of the bike adjacent the tear derailleur 28, the gear cassette 10 and at least the rear part of the drive chain 30.

In accordance with one embodiment of the present invention, the device 2 is formed from a single blank of material 100, as shown in FIG. 2. The device can be moved from the flat, planar blank condition of FIG. 2 when not in use, to an assembled or erect in-use condition, as shown in FIG. 1. In the erect in-use condition, the tray of the second portion 8 protrudes outwardly from the planar surface of the first portion 6 of the device, as will be described in more detail below.

The device 2 is typically made from a relatively flexible sheet like material, such as relatively thin plastic sheet, that allows the device to be moved between flat, erect and/or folded conditions multiple times.

The first portion 6 is formed from a single wall element in this illustration, although it will be appreciated that the first portion could be formed from a plurality of wall elements separated by fold lines, such that the first portion can be folded to a compact size when not in use and moved to an extended flat, planar condition when in use.

Second portion 8 comprises a front wall 32 joined to first portion 6 along fold line 34. Second portion side walls 36, 38 are joined to the side edges of front wall 32 along fold lines 40, 42 respectively.

First portion 6 also has fold lines 44, 46, which are mirror images of fold lines 40, 42. The fold lines 44, 46, 40, 42 adjoin fold line 34 at the same point, to define first portion side walls 48, 50. First portion side walls 48, 50 are joined to second portion side walls 36, 38 along fold lines 52, 54 respectively.

During assembly, front wall 42 is moved towards first portion 6 by folding the front wall along fold line 34. At the same time, side walls 48, 50, 36, 38 are moved inwardly of the device towards each other by folding the walls along fold lines 40, 42, 44, 46, 52, 54. This forms a tray having a rear wall formed from the lower part of the first portion, a front wall 32, side walls 48, 50, 36, 38 and an opening 55 defined between a top edge 56 of the second portion walls. This tray portion allows debris and run off fluid to flow down the front of the first portion, through the opening of the tray portion and be captured in the tray portion for later disposal.

The opening 55 of the tray is typically arranged so that a longitudinal axis of the tray is parallel or substantially parallel to the longitudinal axis of the bike.

Apertures 58 can be defined in front wall 32 and side walls 36, 38, 48, 50 to allow securing means in the form of ties 60 to be located through the same in use to secure the tray portion in the erect condition.

The blank can be moved between the erect/assembled condition and the flat blank condition as often as required. It will also be appreciated that the side walls of the tray portion are collapsible by way of moving the adjacent side wall portions 36, 48 or 38,50 towards each other even after the blank has been assembled. This allows the tray portion to be flattened. As such, the device can be moved to a flat or substantially flat condition even when the blank has been fully assembled to form the tray portion.

The device can be for a single use only and disposable thereafter or can be used multiple times as required.

FIG. 3 illustrates a further embodiment of a blank 102 that can be used to form a brake and disc protection device similar to that shown in FIG. 1. The same reference numerals have been used to describe the same features as in the abovementioned embodiment.

In the further embodiment shown in FIGS. 3 and 4, there are no attachment protrusions 20, 22 and the first portion simply locates around the rear axle of the bike via aperture 18. The first and second portion side walls 36, 48 have been combined to form a single side wall 104 and side walls 38, 50 have been combined to form a single side wall 106. The side walls 104, 106 are joined to first portion along fold lines 44, 46 respectively. The front wall 32 and side walls 104, 106 are of similar size and shape and the fold lines separating the same meet at a point 108. During assembly, front wall 32 is moved towards first portion 6 and side walls 104, 106 are moved towards each other. An apex 110 formed between the outermost edge of front wall 32 and side wall 106 can be secured in a slit 112 defined in second wall 106 to secure the tray portion in the assembled position in use.

Referring to FIGS. 5-8, there is illustrated a further embodiment of a brake and disc protection device 202. Whereas the devices 100, 102 described in FIGS. 1-4 are formed from a single blank, the embodiment shown in FIGS. 5-8 has two blanks that are pivotably movable relative to each other. This pivotal movement helps to engage the device 202 to the wheel of the bike in use.

Brake and disc protection device 202 comprises a first blank 204 and a second blank 206. The second blank 206 is pivotable relative to the first blank 204 around pivot pin 208. The pivot pin 208 passes through the first and second blanks.

First blank 204 comprises a first upper portion 210 and a second lower portion 212. The first upper portion 210 has a circular section 210a with a rectangular section 210b below the circular section. An aperture 214 is defined in the first upper portion 210, and preferably (but not necessarily essentially) in the circular section 210a. This aperture 214 allows the device to be located around an end of the wheel axle of a bike as in the first embodiment. A wedge shaped slot 216 extends outwardly from the aperture 214 to aid fitting of the axle into aperture 214 in use.

Second blank 206 is approximately semicircular in shape in this example, but could be any required shape, providing the second blank 206 does not obstruct the aperture 214 or wedge shaped slot 216 in its disengaged position (as will be described in more detail below). Second blank 206 also has an aperture 218 for location around the end of the wheel axle of the bike in use and a slot 220 extending from the slot to a peripheral edge 222 of the blank.

Second blank 206 is movable from a disengaged position, as shown in FIG. 5, wherein second blank 206 is moved clear of aperture 214 and slot 216, thereby allowing the first blank to be fitted to an end of a bike wheel axle as described above; to an engaged position, as shown in FIG. 6, wherein second blank 206 is moved to cover slot 216. In the engaged position, aperture 218 of the second blank 206 is aligned with aperture 214 of the first blank so that part of the wheel axle of the bike can pass therethrough.

Although the second blank is typically retained in the engaged position by way of gravity, securing means can be provided to allow the first and second blanks to be further retained in the engaged position in use.

In the illustrated embodiment, the securing means are in the form of a flexible tab 224 provided on the second blank for location in securing means in the form of a slot 226 provided on the first blank when the first and second blanks are in the engaged position. The tab is simply flexed and inserted into slot 226. The securing means are typically provided on the opposite side of the pivot pin 208 to the slot 220 and 216 of the second and first blanks respectively. The securing means are typically provided adjacent a peripheral edge of the blanks 204, 206.

The second portion 212 is typically folded in a similar manner to that shown in the first embodiment to form a tray that protrudes outwardly from a front planar surface of the blanks 204, 206 and wheel 16. In particular, second portion 212 has a front wall 232 and two side walls 234, 236 located either side of front wall 232 and joined to front wall 232 along fold line 233, 237 respectively. Second portion 212 is joined to first portion 210 along fold line 238. The lower part 210b of first portion 210 has side walls 240, 242 joined along fold lines 241, 243 respectively. First portion side walls 240, 242 are joined to second portion side walls 234, 236 respectively along fold line 238.

On assembly, the front wall 232 of second portion 212 is moved towards the front wall of first portion 210b. The side walls 240, 242, 234, 236 are folded inwardly of each other along fold lines 241, 243, 233, 237. Securing pins 228 are located through apertures 230 defined on the first and second portions to join the first portion to the second portion and to retain the tray in the erect condition in use.

FIGS. 9a and 9b show an example of a securing pin 228 and/or pivot pint 208 that can be used in the present invention in a separated, disengaged position, and an engaged position respectively.

The pin 228 includes a head portion 244 and a neck portion 246 extending outwardly from said head portion 244. Head portion 244 has a larger cross sectional area than neck portion 246 and aperture 230, such that with the neck portion 246 located through apertures 230, the head portion 244 engages against the surface of the blank and prevents the head 244 and pin 228 from passing further through the aperture 230.

The free end 248 of neck portion 246 has a slot 250 defined therein, the slot having a longitudinal axis that is parallel to the longitudinal axis of the neck portion 246. The slot 250 provides the free end 248 with a degree of flex and/or a degree of resilient biasing force in an outwardly direction. An outwardly protruding lip or shoulder portion 249 is defined a spaced distance from free end 248 on neck portion 246. A nut 252 is provided with an aperture 254 defined therein. The free end 248 of neck portion 246 is located through aperture 254 of nut 252 in use. A step (not shown) provided in the interior walls of nut 252 defining aperture 254 locates over the lip or shoulder portion 249 on neck portion 246 to engage the nut 252 in position on pin 228. The outward resilient biasing force of the free end 248 moves the portions of the free end 248 outwardly of each other to retain the nut 252 in position on the neck portion 246.

FIG. 10 shows an example of a brake and disc protection device fitted around the axle of a front wheel of a bike between the brake disc and the wheel.

1. A device for protecting, allowing cleaning, servicing and/or lubrication of one or more components of a bike and/or vehicle in use, said device formed from at least one blank of material including a first portion arranged to act as a shield element so as to at least partially shield at least one component of the vehicle or bike in use, and at least a second portion, said second portion including at least one wall joined to the first portion by at least one fold line, the at least one wall and fold line arranged such that when the second portion is assembled and/or erected in use it defines a tray or container portion joined to the first portion.

2. A device according to claim 1 in the form of a brake and/or disc protection device, wherein the first portion is arranged so as to at least partially shield a brake and/or disc of a vehicle or bike in use.

3. A device according to claim 1 wherein the first portion and at least second portion are formed from a single blank of material.

4. A device according to claim 1 wherein the second portion comprises or consists of two or more walls, separated by one or more fold lines, the walls and fold lines arranged such that when the second portion is assembled or erected in use, it forms the tray or container portion.

5. A device according to claim 1 wherein the at least one wall of the second portion forms a front wall of the tray or container portion in use and is joined to the first portion along a first fold line, one or more side walls are provided and are joined to the front wall of the second portion and/or to the first portion by at least second or further fold lines.

6. A device according to claim 1 wherein the device is formed from a first blank of material and at least a second blank of material.

7. A device according to claim 1 wherein engagement means are provided on or associated with the at least one blank of material, the first portion and/or the second portion of the device to allow the device to engage with a part of a bike or vehicle in use.

8. A device according to claim 7 wherein the engagement means includes or consists of at least one further blank of material or a second blank of material.

9. A device according to claim 8 wherein the further or second blank of material is movably mounted on or relative to the first blank of material.

10. A device according to claim 9 wherein the second or further blank of material is movable between an engaged position, wherein the second or further blank secures or helps to secure engagement of the first blank to a bike or vehicle in use, and a disengaged position, wherein the second or further blank is moved to a position such that the first blank can be removed from and/or located onto part of a bike or vehicle in use.

11. A device according to claim 9 wherein the second or further blank of material is hingedly, pivotably, rotatably or slidably movable relative to the first blank of material.

12. A device according to claim 7 wherein the engagement means include or are in the form of any or any combination of one or more slits, slots, channels, spaces, recesses and/or apertures.

13. A device according to claim 8 wherein the first blank has engagement means in the form of a slit, slot, channel, aperture and/or recess to allow the first blank to be fitted to a bike or vehicle in use; the second blank is movable relative the first blank to cover at least part of the slit, slot, channel, aperture and/or recess to form an engaged position in use, and wherein the second blank is moved clear or substantially clear of the slit, slot, channel, aperture and/or recess of the first blank to form a disengaged position in use.

14. A device according to claim 9 wherein one or more pin member or pivot means are provided to allow the second or further blank of material to move or pivot relative to the first blank in use.

15. A device according to claim 12 wherein the one or more slits, slots, channels, spaces, recesses and/or apertures are provided from an interior position, central position or relatively central position within the peripheral edge or edges of the blank on the first and/or second blanks of material to a peripheral edge of said blank(s).

16. A device according to claim 1 wherein attachment means or further attachment means are provided on the at least one blank to allow at least part of the device to be attached to at least part of a bike or vehicle in use.

17. A device according to claim 16 wherein the attachment means includes any or any combination of one or more clips, ties, protrusions, tabs, flanges, straps, buckles, inter-engaging members, or hook and loop fastenings.

18. A device according to claim 1 wherein the at least one blank of material includes at least one aperture for location around a rear and/or front axle of a bike or vehicle wheel in use.

19. A device according to claim 18 wherein the at least one aperture is in communication with and/or is continuous with the slit, slot, recess, channel and/or aperture of the engagement means.

20. A device according to claim 1 wherein the first and second portions are arranged such that the tray or container portion, when assembled, is provided at, adjoining or adjacent to a peripheral edge of the first portion.

21. A device according to claim 1 wherein securing means are provided on or associated with the at least one blank to allow two or more blanks to remain in an engaged or disengaged position and/or to allow the first and/or second portions to remain in an assembled and/or erect condition, or a folded and/or collapsed condition in use.

22. A device according to claim 21 wherein the securing means includes any or any combination of one or more apertures, protrusions, tabs, flanges, clips, ties, straps, buckles, pins, inter-engaging members or hook and loop fastenings.

23. A device according to claim 1 wherein the at least one blank of material is formed from or consists of a flexible or a substantially flexible material.

24. A device according to claim 1 wherein the at least one blank of material is formed from or consists of a rigid or substantially rigid material with one or more fold lines or hinge means to allow the second portion to move relative to the first portion in use to form the tray or container portion.

25. A device according to claim 1 wherein the at least one blank of material is formed from, consists of or includes a sheet like material.

26. A device according to claim 1 wherein one or more frangible means, weakened sections and/or partial cut lines are provided on the at least one blank of material to allow the material blank to be cut to a required size, shape and/or design in use.

27. A method of forming a device for protecting, allowing cleaning, servicing and/or lubrication of one or more components of a bike and/or vehicle in use, said device comprising at least one blank of material including a first portion arranged to act as a shield element so as to at least partially shield at least one component of the vehicle or bike in use, and at least a second portion, said second portion including at least one wall joined to the first portion by at least one fold line, said method including the steps of folding the at least one wall of the second portion along the at least one fold line to form a tray or container portion joined to the first portion.

28. A blank of material for forming the device according to claim 1.

29. First and at least second blanks of material for forming the device according to claim 1.
